(19) United States
(12) Patent Application Publication
(10) Pub. No.: US 2013/0342158 A1
(43) Pub. Date: Dec. 26, 2013

(54) IN-VEHICLE CHARGING ADAPTOR DEVICE

(71) Applicant: Jinhong Zhong, SHENZHEN (CN)

(72) Inventor: Jinhong Zhong, SHENZHEN (CN)

(21) Appl. No.: 13/919,180

(22) Filed: Jun. 17, 2013

(30) Foreign Application Priority Data
Jun. 20, 2012 (CN) 201220306127.2

(51) Int. Cl. H02J 7/00; H01R 13/66

(52) U.S. Cl. CPC H02J 7/0042; H02J 7/0047; H01R 13/665
USPC 320/107; 439/148

(57) ABSTRACT

An in-vehicle charging adaptor device includes a plug main body and a cap separatably matched with the plug main body. The plug main body has a cigarette lighter plug formed at one end thereof, an USB socket formed at the other end thereof. A circuit device is received in the plug main body electrically connected with the cigarette lighter plug and the USB socket. The present invention has reasonable structure design, reliable function, and convenient practical usage with decorative function.

### BACKGROUND OF THE INVENTION

1. Field of the Invention

The present disclosure is related to an electronic product having mechanical structure and circuit design. In particular, the present disclosure relates to a charging adapter device.

2. Description of Related Art

With the development of electronic technology, various electronic products had become daily life's necessities, such as mobile phone, MP3 player, digital camera, etc. However, all of these electronic products need power supply to function well, and usually are equipped with chargeable batteries for supplying power. To miniaturize the measure, the capacity of battery is very limited, and the battery needs to be frequently charged when running out. The most common charging way is connecting to city power, which are limited in indoors or buildings, thus this way is very inconvenient for users during outdoor activities.

Cigarette lighter socket is a standard equipment of an automobile, which can provide direct current of 12 voltages. Therefore, it is useful and convenient way to use the cigarette lighter socket for charging the electronic products. Currently, there are some adapter devices for the cigarette lighter socket, which have one end plugged in the cigarette lighter socket, and the other end is connected to the charging port of the electronic product. However, the charging ports of the electronic products are designed in various ways, and users need to use different adapter device for various electronic products.

Recently, it is more and more popularly to get electricity power from USB port. Many electronic products are equipped with a charging device of a city power and a charging cord. The charging cord has an USB plug at one end, and a specific plug at the other end which matches with the charging port of the electronic device.

### SUMMARY OF THE INVENTION

The present invention provides an in-vehicle charging adaptor device, which has reasonable structure design, reliable function, and convenient practical usage with decorative function.

The above purposes can be achieved by the following embodiment. An in-vehicle charging adaptor device includes a plug main body, and a cap separatably connected with the plug main body. The plug main body has a cigarette lighter plug formed at one end thereof, an USB socket formed at the other end thereof, and a circuit device received therein to electrically connect the cigarette lighter plug and the USB socket.

Further, according to an embodiment of the present invention, the cap is formed with a matching opening corresponding to a contour of the cigarette lighter plug, and the cap is separatably sleeved on the cigarette lighter plug.

Further, according to an embodiment of the present invention, a connecting coordination mechanism is disposed between the cap and the cigarette lighter plug.

Further, according to an embodiment of the present invention, the connecting coordination mechanism is magnet disposed in an inner top end of the cap and a magnetized terminal disposed on a top end of the cigarette lighter plug.

Further, according to an embodiment of the present invention, the connecting coordination mechanism is a wedging piece and a wedging groove.

Further, according to an embodiment of the present invention, the cap has a guiding protrusion formed adjacent to the matching opening of the cap, wherein the cigarette lighter plug is formed with a guiding slot along a longitudinal direction thereof corresponding to the guiding protrusion.

Further, according to an embodiment of the present invention, the cap has a hanging mechanism formed on a top end thereof so as to be hanged.

Further, according to an embodiment of the present invention, a supporting mechanism is disposed on the plug main body adjacent to the USB socket so as to support the in-vehicle charging adaptor device.

Further, according to an embodiment of the present invention, the circuit device includes a fuse, a DC buck-convertor module, a protection circuit module and an indicator light; wherein the fuse has an inputting end connected to a corresponding conductive terminal of the cigarette lighter plug and an outputting end connected to the DC buck-convertor module; the DC buck-convertor module has an outputting end connected to an inputting end of the protection circuit module; the protection circuit module has an outputting end connected to a corresponding terminal of the USB socket; the outputting end of the protection circuit module is further connected to the indicator light.

Therefore, the present disclosure has advantages as followed. First, the cap can protect the cigarette lighter plug. The charging adaptor device can be hanged in car after the cap connected with the plug main body, and has decorative function. The structure design is reasonable. Second, the circuit device disposed in the plug main body provides a stable and reliable converter function with an indicator light. Third, after the plug main body is pulled from the cap and inserted in the opening of the cigarette lighter socket of car, and an USB charging cord is connected to the USB socket, then an electronic device can be charged. It is operated conveniently.

For further understanding of the present disclosure, reference is made to the following detailed description illustrating the embodiments and examples of the present disclosure. The description is for illustrative purpose only and is not intended to limit the scope of the claim.

### BRIEF DESCRIPTION OF THE DRAWINGS

FIG. 1 is a perspective view of an adapter device according to an embodiment of the present invention;

FIG. 2 is a perspective view of a cap separated from a plug main body of the adapter device according to an embodiment of the present invention;

FIG. 3 is bottom view of the cap of the adapter device according to an embodiment of the present invention; and

FIG. 4 is a block diagram of the adapter device according to an embodiment of the present invention.

### DETAILED DESCRIPTION OF THE PREFERRED EMBODIMENTS

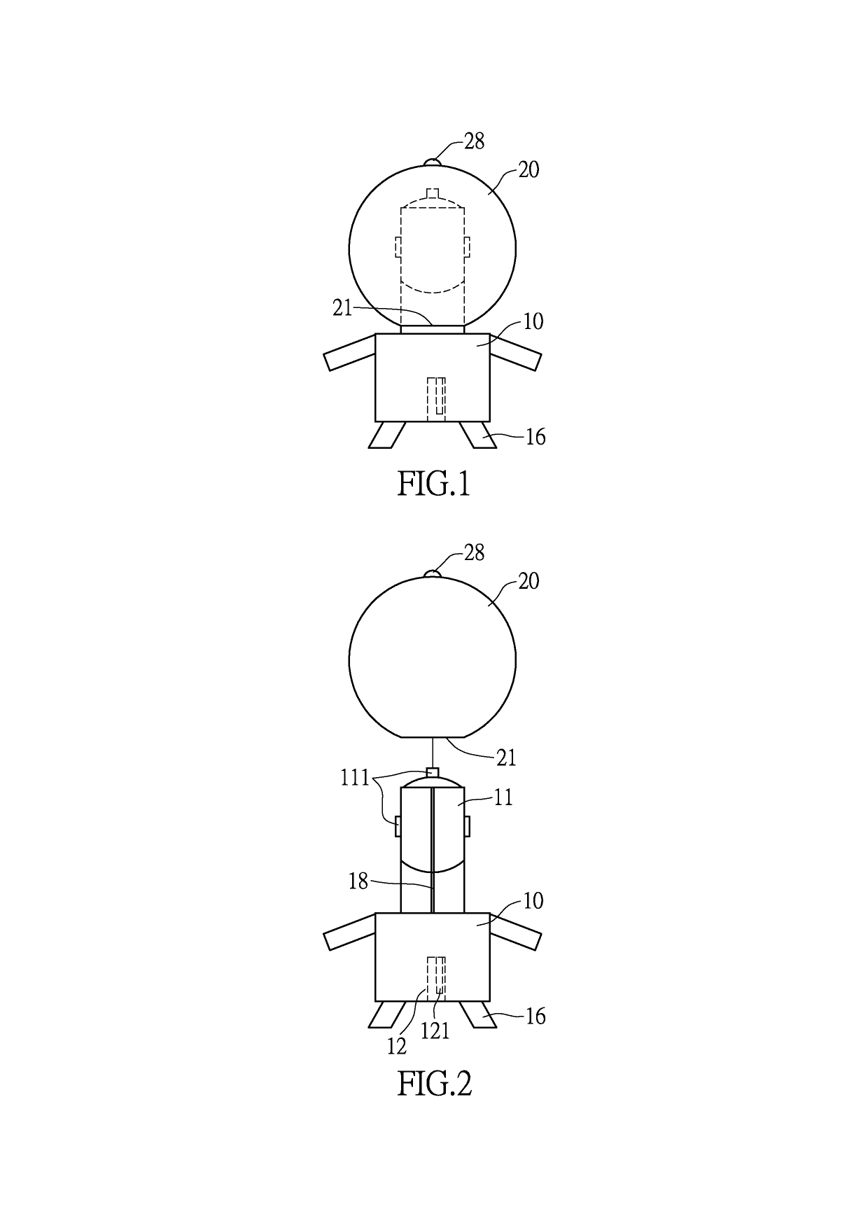

Please refer to FIG. 1. The present invention provides an in-vehicle charging adaptor device, which includes a plug main body 10 and a cap 20. The cap 20 is separatably matched with the plug main body 10.

As shown in FIG. 2, the plug main body 10 has a cigarette lighter plug 11 formed at one end thereof, an USB socket 12 formed at the other end thereof. The cigarette lighter plug 11 and the USB socket 12 respectively have lighter plug terminals 111 and socket terminals 121. The plug main body 10 has a circuit device (as shown in FIG. 4) disposed therein, and is electrically connecting the cigarette lighter plug 11 and the USB socket 12.

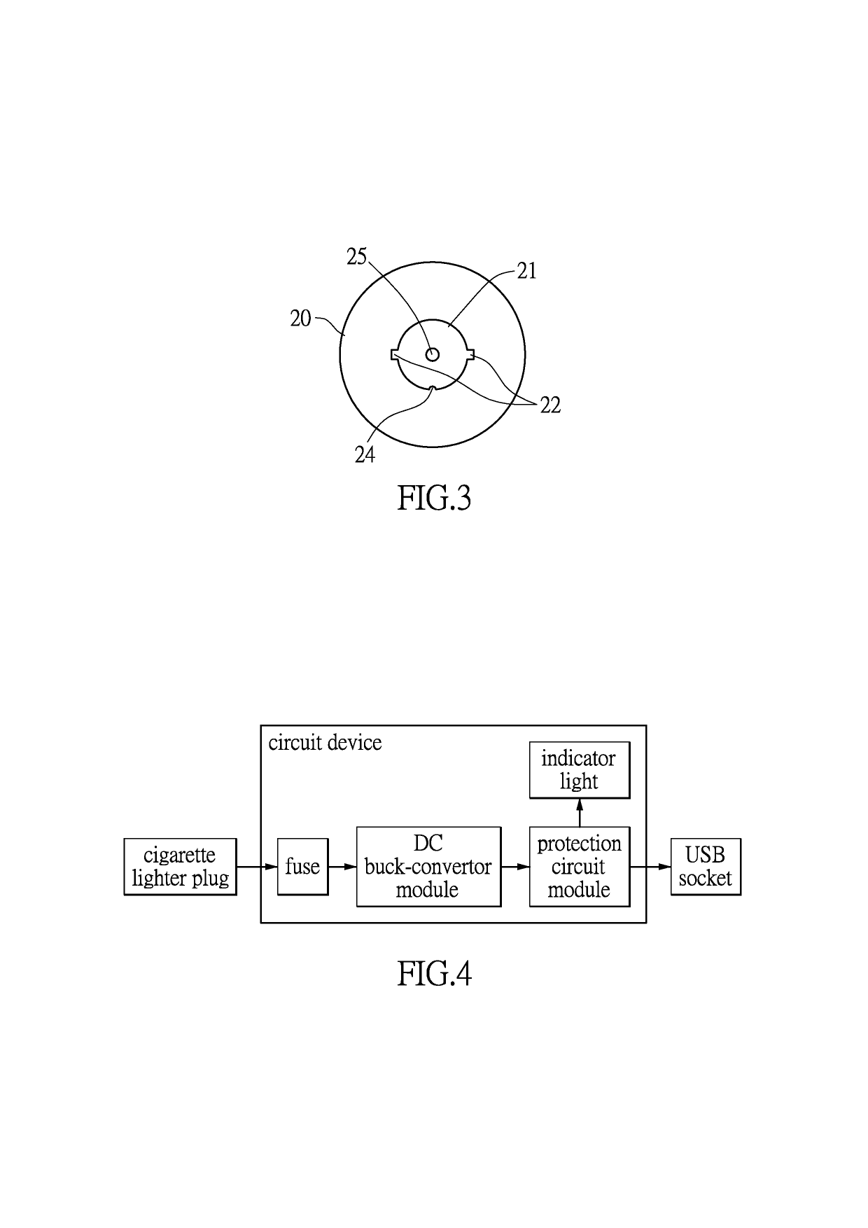

Please refer to FIG. 2 and FIG. 3. A lower end of the cap 20 is formed with a matching opening 21. The matching opening 21 has a contour corresponding to a shape of the cigarette lighter plug 11, which is substantially circular-shaped. Further, the cap 20 has a pair of rail grooves 22 formed on two inner sides of the matching opening 21. In this embodiment, the cap 20 is separatably sleeved on the cigarette lighter plug 11. Besides, there is a connecting coordination mechanism is disposed between the cap 20 and the cigarette lighter plug 11. The connecting coordination mechanism can be applied in different manners. To consider that the top end of the cigarette lighter plug 11 has one terminal, which is usually is made of ferrous material, a magnet 25 is disposed in an inner top end of the cap 20 in this embodiment. The connecting coordination mechanism thus includes the magnetized terminal (111) and the magnet 25. When the cap 20 is sleeved on the cigarette lighter plug 11, the top terminal (111) on the top end of cigarette lighter plug 11 just is magnetically attracted to the magnet 25. In an additional embodiment, the connecting coordination mechanism could include a wedging piece and a wedging groove formed between the cap 20 and the cigarette lighter plug 11 matched to each other.

To conveniently match the cigarette lighter plug 11 with the cap 20, the cap 20 can has a guiding protrusion 24 formed adjacent to the matching opening 21 of the cap 20. The cigarette lighter plug 11 is correspondingly formed with a guiding slot 18 (as shown in FIG. 2) along a longitudinal direction thereof to match with the guiding protrusion 24.

Please refer to FIG. 1 and FIG. 2 continuously. The cap 20 has a hanging mechanism 28 formed on a top end thereof so as to provide a hanging function. Further, there is a supporting mechanism 16 formed on the plug main body 10 adjacent to the USB socket 12, so as to support the in-vehicle charging adaptor device. In a practically design for products, the cap 20 and the USB socket 12 can be designed in cartoons or animal appearances. Thus, the present invention also provides decorative functions, when it is hanged or furnished.

As shown in FIG. 4, the circuit device, which is disposed in the plug main body 10, includes a fuse, a DC buck-convertor module, a protection circuit module and an indicator light. The fuse has an inputting end connected to a corresponding conductive terminal of the cigarette lighter plug 11 and an outputting end connected to the DC buck-convertor module. The DC buck-convertor module has an outputting end connected to an inputting end of the protection circuit module. The protection circuit module has an outputting end connected to a corresponding terminal of the USB socket 12. The outputting end of the protection circuit module is further connected to the indicator light. The indicator light can be LED light of higher power.

Some modifications of these examples, as well as other possibilities will, on reading or having read this description, or having comprehended these examples, will occur to those skilled in the art. Such modifications and variations are comprehended within this invention as described here and claimed below. The description above illustrates only a relative few specific embodiments and examples of the invention. The invention, indeed, does include various modifications and variations made to the structures and operations described herein, which still fall within the scope of the invention as defined in the following claims.

What is claimed is:

1. An in-vehicle charging adaptor device, comprising:
a plug main body; and
a cap, separatably matched with said plug main body;
wherein said plug main body has a cigarette lighter plug formed at one end thereof, an USB socket formed at the other end thereof, and a circuit device received therein to electrically connect said cigarette lighter plug and said USB socket.

2. The in-vehicle charging adaptor device as claimed in claim 1, wherein said cap is formed with a matching opening corresponding to a contour of said cigarette lighter plug, wherein said cap is separatably sleeved on said cigarette lighter plug.

3. The in-vehicle charging adaptor device as claimed in claim 2, further comprising a connecting coordination mechanism is disposed between said cap and said cigarette lighter plug.

4. The in-vehicle charging adaptor device as claimed in claim 3, wherein said connecting coordination mechanism has a magnet disposed in an inner top end of the cap and a magnetized terminal disposed on a top end of the cigarette lighter plug.

5. The in-vehicle charging adaptor device as claimed in claim 3, wherein said connecting coordination mechanism includes a wedging piece and a wedging groove.

6. The in-vehicle charging adaptor device as claimed in claim 2, wherein said cap has a guiding protrusion formed adjacent to said matching opening of said cap, wherein said cigarette lighter plug is formed with a guiding slot along a longitudinal direction thereof corresponding to said guiding protrusion.

7. The in-vehicle charging adaptor device as claimed in claim 1, wherein said cap has a hanging mechanism formed on a top end thereof so as to be hanged

8. The in-vehicle charging adaptor device as claimed in claim 1, further comprising a supporting mechanism formed on said plug main body adjacent to said USB socket so as to support said in-vehicle charging adaptor device.

9. The in-vehicle charging adaptor device as claimed in claim 1, wherein said circuit device includes a fuse, a DC buck-convertor module, a protection circuit module and an indicator light, wherein said fuse has an inputting end connected to a corresponding conductive terminal of said cigarette lighter plug and an outputting end connected to said DC buck-convertor module, said DC buck-convertor module has an outputting end connected to an inputting end of said protection circuit module, said protection circuit module has an outputting end connected to a corresponding terminal of said USB socket, the outputting end of said protection circuit module is further connected to said indicator light.
